(19) United States
(12) Patent Application Publication
(10) Pub. No.: US 2023/0074391 A1
(43) Pub. Date: Mar. 9, 2023

(54) COMPACT STACK VALVE GATE

(71) Applicant: HUSKY INJECTION MOLDING SYSTEMS LTD., BOLTON (CA)

(72) Inventor: Sarah Kathleen OVERFIELD, Colchester, VT (US)

(21) Appl. No.: 17/759,733

(22) PCT Filed: Feb. 3, 2021
(86) PCT No.: PCT/US2021/016346

§ 371 Date: Jul. 29, 2022

Related U.S. Application Data
(60) Provisional application No. 62/969,904, filed on Feb. 4, 2020.

(51) Int. Cl. B29C 45/28; B29C 45/22

(52) U.S. Cl. CPC B29C 45/2806; B29C 45/22; B29C 2045/2762

(57) ABSTRACT

An injection molding system is disclosed herein that may include a manifold that may have a manifold melt channel for receiving melted resin, a nozzle having a nozzle melt channel for receiving the melted resin from the manifold melt channel and delivering the melted resin to a mold cavity via a mold gate. In other examples, a valve pin may extend through at least a portion of the nozzle melt channel such that a forward end of the valve pin may be seatable within the mold gate. In certain examples, the injection molding system may include one or more drop plate, each of which defines walls of a cylinder within which a piston reciprocates, and each which may contain cooling circuits and pressurized circuits for opening and closing the piston. With regard to injection molding system containing multiple drop plates, each drop plate is independent of the other drop plates, and each drop plate is dedicated to a single nozzle assembly. In other examples, the drop plates may house a valve pin coupling system configured to permit movement of a valve pin in a lateral direction independent from a lateral position of the piston.

### BACKGROUND

Basic valve gate hot runner injection molding systems typically include a resin distribution system, plates that enclose the distribution system, nozzles that direct the outflowing resin to cavities for molding, and actuation hardware that opens and closes the resin flow path of a given nozzle into its respective cavity. A valve pin provides the resin flow path gating function. The valve pins are typically connected and secured to a piston in a way that does not permit the valve pin to move laterally or independently of the lateral position of the piston. The piston rides within a cylinder chamber contained in a backing plate, as shown in FIG. 1. The piston rides piston seals and is driven from the open to closed positions by pressurized circuits. The pressurized circuits are typically routed through the backing plate that is connected to a cylinder chamber through the cylinder opening on the top side for the close movement and through pass through channels in a backup pad for the open movement. The backing plate may further contain cooling lines in an attempt to manage the exit temperature of the manifold bushing. Managing the exit temperature of the manifold bushing helps to minimize the amount of resin that escapes the distribution system. In existing hot runner systems, however, managing the exit temperature of the manifold bushing can be difficult to achieve given that the placement and arrangement of the cooling lines are dictated and limited by the features of the backing plate. In this typical arrangement, the piston, cylinder, and valve pin are all aligned to a manifold bushing and a manifold. Such alignment requires that the axial location of these components is dictated by the axial position of the manifold bushing bore in the manifold.

Since the manifold is a heated component, feature axial positions change due to thermal expansion as the manifold temperature increases from room temperature to its operating temperature required to melt resin. As the system components expand due to the increased operating temperatures, the components can become misaligned. The misalignment is problematic in hot runner systems because as the valve pin becomes misaligned, due to the thermal expansion and movement of the manifold, the valve pin experiences increased side loading and lateral stress. The increased loading and increased stress may damage the valve pin resulting in undue weepage or loss of melted resin from the distribution system. The thermal expansion creates an unresolved conflict: to best seal resin from escaping the runner system, the stem must be aligned to the manifold bushing while to best seal the actuation system, the stem and piston must be aligned to the cylinder. In a standard arrangement, these two conditions cannot be met simultaneously.

It is an object of the injection molding systems and methods disclosed herein to provide a novel solution to the problems associated with cooling the actuating system and cooling the manifold bushing of injection molding systems. The injection molding systems disclosed herein include a newly designed drop plate that defines walls of a cylinder within which a piston reciprocates. The injection molding systems may have multiple drop plates, with each drop plate independent of the other drop plates, and each drop plate dedicated to a single nozzle assembly. The novel drop plate includes cooling circuits in close proximity to the actuating system and manifold bushing, resulting in more effective management of the exit temperatures of the manifold bushing, which in turn, reduces the amount of melted resin escaping the system during use. An additional benefit of the novel drop plate design is that it provides improved access to the system for maintenance and repair.

It also an object of the unique injection molding systems and methods disclosed herein to eliminate damage to the system caused by misalignment of the system components due to thermal expansion. The injection molding system disclosed herein includes a valve pin coupling system configured to permit movement of the valve pin in a lateral direction independent from a lateral position of the piston. This design minimizes the axial misalignment of the valve pin due to thermal expansion and extends the life of the valve pin.

It also an object of the unique injection molding systems and methods disclosed herein to reduce the overall shut-height and weight of the injection molding system. By employing the novel drop plate that defines the walls of the cylinder in which the piston reciprocates, and eliminating the need for a back plate used in conventional systems, the overall shut-height of the system is reduced. The unique valve pin coupling system disclosed herein further results in a reduction in the overall shut-height of the system. The injection molding systems disclosed herein also include a unique nozzle locator that engages the manifold plate at multiple points minimizing axial misalignment due to thermal expansion and further reduces the system shut-height. In addition, the stack valve gate hot runner arrangement disclosed herein eliminates the center plate requirement of conventional systems, which further reduces system shut-height and overall system weight.

### BRIEF SUMMARY

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

Injection molding systems have various features that are described herein. In some embodiments, a hot runner system is disclosed that may include a plurality of nozzles, a plurality of corresponding drop plates wherein each drop plate may be independent of the other drop plates and may be dedicated to a single nozzle. In some examples, each drop plate may define a cylinder that a piston can ride or reciprocate within, and a valve pin associated with each drop plate and each nozzle. In certain examples, the valve pin may be configured to extend from the piston through at least a portion of the nozzle melt channel such that a forward end of the valve pin may be seatable within the mold gate. In still other examples, the drop plates may be bolted to separate manifold plates, and each drop plate may be associated with a separate manifold, and each drop plate may be configured to seal melted resin within a manifold cavity in the manifold. In another example, the hot runner drop plates may further include a rod seal, and the drop plates may be configured to seal air in the cylinder. In yet another example, the hot runner system may also include an insulator board configured to cover the plurality of drop plates and plurality of nozzles to reduce system contaminants. In one example, each drop plate may further include a cooling circuit. In certain examples, each drop plate may also include a first and a second air circuit.

In other embodiments, an injection molding system is disclosed herein that may include a manifold having a manifold melt channel for receiving melted resin, a nozzle having a nozzle melt channel for receiving the melted resin from the manifold melt channel and delivering the melted resin to a mold cavity via a mold gate, an actuating system that may include a cylinder that a piston rides within, a valve pin configured to extend from the piston through at least a portion of the manifold melt channel and the nozzle melt channel such that a forward end of the valve pin is seatable within the mold gate, and a valve pin connecting assembly that may be configured to connect the valve pin to the piston, and configured to permit the valve pin to move in a lateral direction independent from a lateral position of the piston. In another example, the valve pin connecting assembly may include a stem holder, a slider, and a retaining ring. In certain examples, a stem head of the valve pin may be seated between the stem holder and a bottom portion of the piston. In some examples, the retaining ring may retain the slider to the piston, and the stem holder may be configured to be in sliding engagement with the slider and the bottom portion of the piston to permit the valve pin to move in a lateral direction independent from a lateral position of the piston. In yet other examples, the injection molding system disclosed herein may also include a drop plate that may define a cylinder that the piston may be configured to ride within. In still other examples, the injection molding system drop plate may further include a cooling circuit or line, and a plurality of air circuits or lines to drive the piston between an open position to a closed position.

In another example disclosed herein, an injection molding system may include a plurality of nozzles, a plurality of corresponding drop plates in which each drop plate may be independent of the other drop plates and may be dedicated to a single nozzle. In some examples, each drop plate may define a cylinder wall that a piston may ride within, and a valve pin may be associated with each drop plate and may be configured to engage the piston. In other examples, valve pin connection assembly may be configured to connect the valve pin to the piston, and the valve pin connection assembly may be configured to permit axial movement of the valve pin relative to the piston. In still other examples, the injection molding system valve pin connection assembly may include a stem holder, slider, and a retaining ring. In certain examples, a stem head of the valve pin may be seated between the stem holder and a bottom portion of the piston. In some examples, the retaining ring may retain the slider to the piston, and the stem holder may be configured to be in sliding engagement with the slider and the bottom portion of the piston to permit the valve pin to move in a lateral direction independent from a lateral position of the piston. In still other example injection molding systems disclosed herein, the drop plate may further include a cooling circuit. In various examples, the drop plate may also include a circuit for pressurized air or fluid to drive the piston between an open position and a closed position.

In still other embodiments disclosed herein, an injection molding system may comprise a melted resin distribution system comprising a first manifold and a second manifold, a first drop plate configured to connect to a first manifold plate. In certain examples, the first drop plate may define a cylinder that a first piston may ride within. In some examples, a second drop plate may be configured to abut the first drop plate and configured to connect to a second manifold plate, the second drop plate defining a first cylinder that a first piston rides within. In some example a first valve pin may be configured to engage the first piston and may extend from the first piston through at least a portion of a melt channel in the first manifold and a first nozzle melt channel such that a forward end of the first valve pin is seatable within a first mold gate. In another example, a second valve pin may be configured to engage the second piston and may extend from the second piston through at least a portion of a melt channel in the second manifold and a second nozzle melt channel such that a forward end of the second valve pin is seatable within a second mold gate. In other examples, the first drop plate and second drop plate may be located between the first manifold plate and the second manifold plate.

In still other example injection molding system disclosed herein, each drop plate may contain a valve pin connection assembly configured to connect the valve pin to the piston, and the valve pin connection assembly may be configured to permit axial movement of the valve pin relative to the piston. In other examples, the valve pin connection assembly may comprise a stem holder, slider, and a retaining ring. In certain examples, a stem head of the valve pin may be seated between the stem holder and a bottom portion of the piston. In another example, the retaining ring may secure the slider to the piston, and the stem holder may be configured to be in sliding engagement with the slider and the bottom portion of the piston to permit the valve pin to move in a lateral direction independent from a lateral position of the piston. In yet another example, each of the first and second drop plates may further include a cooling circuit and a pressured circuit for driving each of the pistons between an open position and a closed position.

In still other embodiments disclosed herein, an injection molding system may comprise a melted resin distribution system comprising a manifold, a nozzle assembly, a valve pin configured to extend through at least a portion of a nozzle melt channel in the nozzle assembly such that a forward end of the valve pin may be seatable within a mold gate. In some examples, a nozzle locator may be configured to engage the manifold plate and the outside surface of the nozzle assembly. In other examples, the nozzle locator may engage a first manifold plate shelf In another example, the drop plate may also include a cooling circuit and a plurality of air circuits to drive the piston between an open position and a closed position.

These and various other features will be described more fully herein.

### BRIEF DESCRIPTION OF THE DRAWINGS

The present invention is illustrated by way of example and not limited in the accompanying figures in which like reference numerals indicate similar elements and in which:

FIG. 1 is a sectional view through a prior art, standard individual pneumatic valve gate hot runner system.

FIG. 2 is a sectional view through a compact stack valve gate individual hot runner system according to one or more aspects described herein.

FIG. 3 is an expanded sectional view of the actuation hardware of the compact stack valve gate individual hot runner system of FIG. 2 according to one or more aspects described herein.

FIG. 4 is a sectional view through a prior art, standard stack valve gate hot runner system.

FIG. 5 is a sectional view through a stack valve gate hot runner arrangement for a hot runner system with individual compact stack valve gates according to one or more aspects described herein.

Further, it is to be understood that the drawings may represent the scale of different components of one single embodiment; however, the disclosed embodiments are not limited to that particular scale.

### DETAILED DESCRIPTION

Aspects of this disclosure relate to injection molding systems. Injection molding systems generally include an injection molding unit and a hot runner system, wherein the hot runner system has one or more manifolds and one or more nozzles in fluid communication with each other. The hot runner manifolds receive a resin melt stream of moldable material from the injection molding unit and transfer the resin melt stream to one or more mold cavities via a respective hot runner nozzle.

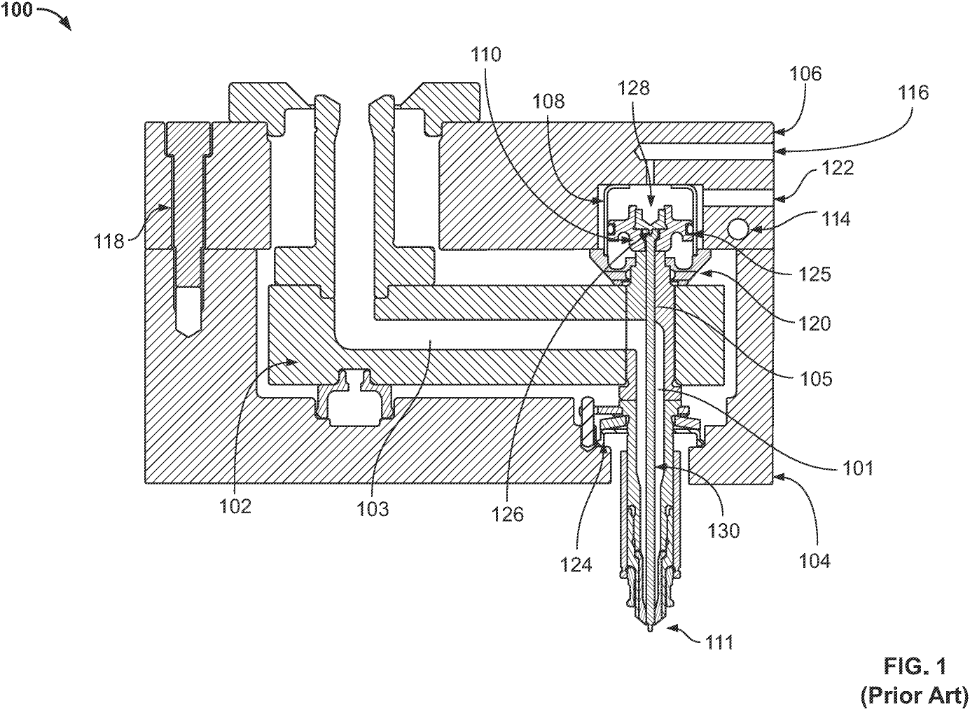

FIG. 1 illustrates the standard arrangement for a single face, single manifold, individual valve gate hot runner system 100. The system includes a manifold 102, a manifold plate 104, a backing plate 106, and a nozzle assembly 111. The backing plate 106 is secured to the manifold plate 104 via a socket head cap screw(s) 118. A manifold bushing 105 is assembled through a bore in the manifold 102, aligning a melt channel 101 in the manifold bushing 105 with a melt channel 103 in the manifold 102. A valve pin or stem 130 extends from and is coupled to an actuating system. The actuation hardware of the actuating system comprises a piston 110 that reciprocates in a cylinder 108, and a piston seal 125. The actuator hardware is housed in an actuator cavity formed in the backing plate 106. The valve pin 130 includes a valve head 126 that is secured to the piston 110 via a set screw 128. The valve pin 130 passes through the manifold bushing 105 and extends into and through a melt channel 103 of the nozzle assembly 111 to have a downstream end seatable within a mold gate of a mold cavity.

Control of the resin melt stream is achieved by raising (i.e., opening) and lowering (i.e., closing) the valve pin 130 via the actuating system. Retracting the valve pin 130 from the mold gate permits the resin melt stream to flow into the mold cavity while re-seating the downstream end of the valve pin 130 within the mold gate prevents further flow of the resin melt stream into the mold cavity. Although only one actuating system and nozzle assembly 111 is shown in FIG. 1, the system 100 may include multiple actuating systems and nozzle assemblies. In such systems, the backing plate 106 houses the actuating systems in separate and distinct cavities, and the backing plate 106 covers all of the nozzles and prevents contaminants from entering the system.

While the piston 110 may be driven by pressurized air or fluid, the backing plate 106 shown in FIG. 1 further includes pressurized air circuits, to include air closed line 116 and air open line 122 that drives the piston 110 from the open to closed positions. The piston seal 125 of the piston 110 slides on the inner surface of cylinder 108 maintaining an air seal between the opposing faces of the piston such that when compressed air is admitted via the air closed line 116 in the top of cylinder 108, it causes the piston to move downward, thereby closing the gate of a mold cavity with the valve pin 130. When compressed air is admitted via air open line 122 in the side wall of cylinder 108, it causes the piston to move upward thereby opening the gate by retracting the valve pin 130. The backing plate 106 may further contain cooling line 114 in an attempt to manage the exit temperature of the manifold bushing 105. Managing the exit temperature of the manifold bushing 105 helps to minimize the amount of resin that escapes the distribution system. In existing hot runner systems, like that shown in FIG. 1, managing the exit temperature of the manifold bushing 105 can be difficult to achieve given that the placement and arrangement of the cooling lines 114 are dictated and limited by the features of the backing plate 106.

It is known in the art that dimensional variations in the components of existing hot runner systems, especially the hot runner manifold, occur as a result of heat expansion and cooling during operation. The thermal expansion and contraction may misalign the system components and may cause damage to the components. For example, under operating conditions, the thermal expansion of the manifold 102 can shift and misalign the manifold 102 relative to backing plate 106. When the misalignment exceeds system tolerances, elongated valve pin 103 may be subjected to side loading and excessive bending forces due to mechanical interference. The misalignment or deflection leads to bending and subsequent damage of the valve pins and then damage to the mold gates. The damage to the valve pin 130 and mold gates leads to a loss of control of the flow of the resin melt stream due to improper or inadequate seating of the valve pin 130 in the mold gates due to the inadequate seating of the tip of the valve pins 130 in the mold gates and/or changes in timing of closing of the mold gates. In addition to excessive wear on the elongated valve pin 130, the actuation mechanism is placed under considerable load, decreasing system efficiency, and increasing the likelihood of pin seizure and/or actuator system malfunction.

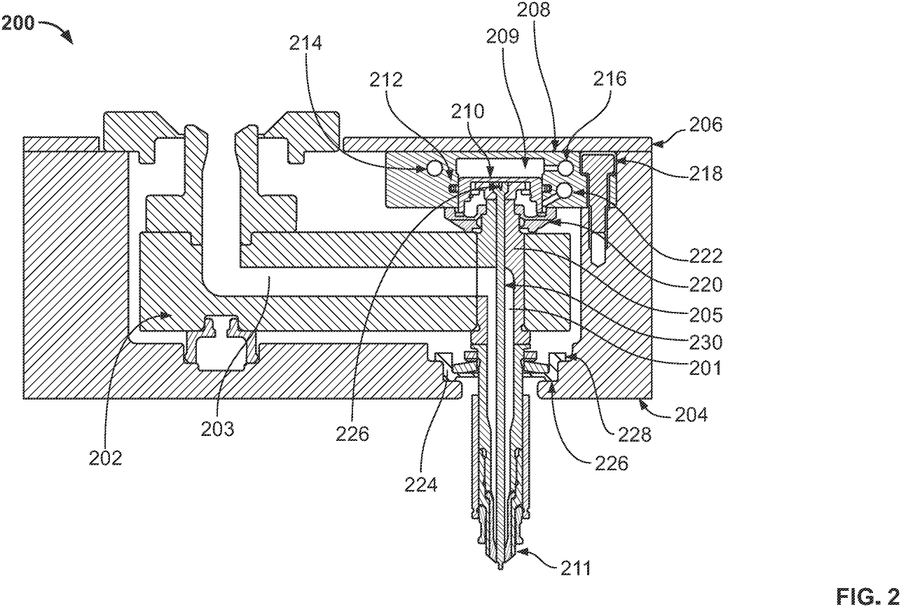

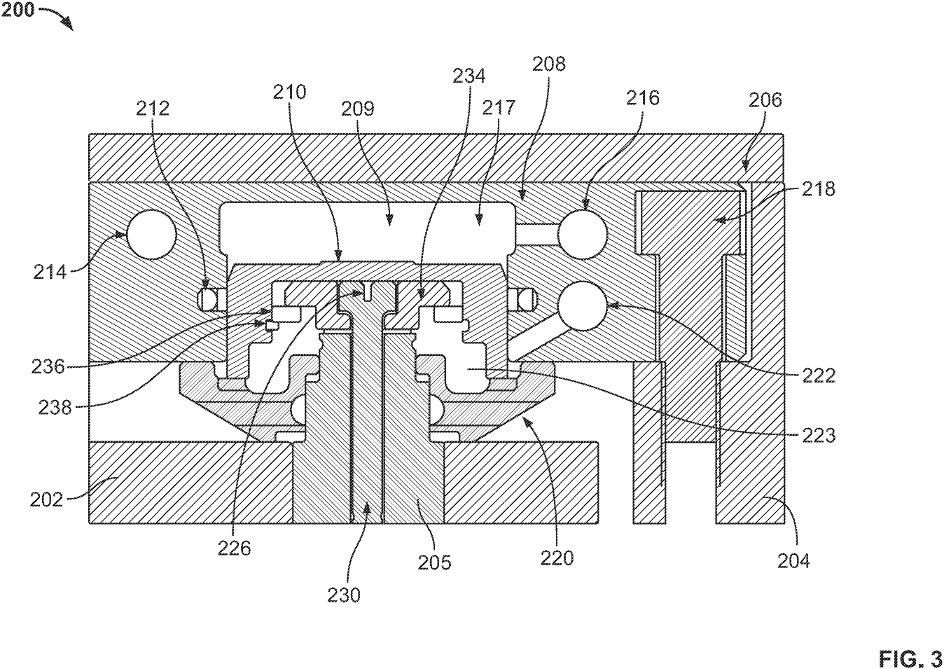

FIGS. 2 and 3 illustrate an embodiment of a unique compact stack valve gate hot runner system disclosed herein that provides several advantages over existing systems, including improved cooling of the actuating system and manifold bushing, reducing misalignment of the components due to thermal expansion, and reduction in overall shut-height and weight of the injection molding system. The system 200 includes a manifold 202, manifold plate 204, manifold bushing 205, and nozzle assembly 211. The system replaces the backing plate found in conventional systems with an insulator board 206 and a drop plate 208. The drop plate 208 is fastened to the manifold plate 204 by socket head cap screws 218. This attachment provides a nozzle sealing load generation function rather than employing a conventional, separate backing plate as shown in system 100 in FIG. 1. The drop plate 208 provides the drop force generation eliminating the need for a backing plate found in convention systems. The insulator board 206 is attached to the manifold plate 204 to function as a cover for the system and to prevent contaminants from entering the system 200.

The drop plate 208 of the system 200 defines an interior cylinder chamber/wall 209. Piston 210 reciprocates within the cylinder 209 formed in the drop plate 208. The system 200 further includes nozzle assembly 211, nozzle locator 224, valve pin 230 extending from and coupled to the piston 210, backup pad 220, and rod seal 212. The valve pin 230 may include a valve head 226 and a valve stem 232. Valve pin 230 passes through the manifold bushing 205 and extends into and through a melt channel 203 of the nozzle assembly 211 to have a downstream end seatable within a mold gate of a mold cavity (not shown). Like conventional systems, control of the resin melt stream is achieved by raising (i.e., opening) and lowering (i.e., closing) the valve pin 230. Retracting the valve pin 230 from the mold gate permits the resin melt stream to flow into the mold cavity while re-seating the downstream end of the valve pin 230 within the mold gate prevents further flow of the resin melt stream into the mold cavity.

While the piston 210 may be driven by pressurized air or fluid, the embodiment in FIGS. 2 and 3 contains a drop plate 208 with pressurized air circuits, to include air closed line 216 and air open line 222 that drives the piston 210 from the open to closed positions. The wall of the cylinder 209 formed in the drop plate 206 comprises a groove and has arranged therein the rod seal 212. The rod seal 212 separates and seals the upper and lower parts of the cylinder/chamber from each one another.

Drop plate 208 further includes a cooling circuit 214 in close proximity to the actuating system for direct cooling of the cylinder 209. The cooling circuit 214 also has the benefit of controlled proximity to the manifold bushing 205. The unique drop plate 206 that permits placement of the cooling circuit 214 in close proximity to both the cylinder 209 and manifold bushing 205 is an improvement over existing systems where the placement and arrangement of the cooling lines are dictated and limited by the features of the backing plate 106. The ;unique drop plate 206 that permits the cooling circuit 214 in close proximity to both the cylinder 209 and manifold bushing 205 increases the life of seals in the actuating system and reduces the variation of and improves the control of drop to drop manifold bushing exit temperature, which, in turn, results in better management of resin weepage out of the manifold bushing 205

Although only one drop plate 208 and nozzle assembly 211 is shown in FIGS. 2 and 3, system 200 may include a number of such drop plates and nozzle assemblies. In systems with multiple drop plates and nozzles assemblies, each drop plate may be independent of the other drop plates. In addition, each drop plate 208 may have its own actuating system and may be dedicated to a single nozzle assembly 211. The insulator board 206 covers all of the drop plates 208 and nozzle assemblies 211 to contain the resin distribution system and to prevent contaminants from entering the system 200. This improved configuration results in improved access to individual actuating systems and nozzle assemblies for maintenance and repair. For example, to access an individual actuating system or nozzle assembly of the system, an operator need only remove the drop plate 208 associated with such actuating system or nozzle assembly. In comparison, existing systems require removal of the entire backing plate to access any of the actuating systems or nozzle assemblies, which, in turn, increases the risk of contamination and debris entering the system when the entire backing plate is removed and is more time consuming.

A valve pin connection assembly is provided to disassociate the valve pin’s axial position from the piston’s axial position thereby eliminating the effects of side loading and lateral displacement forces. As shown in FIG. 3, the valve pin connection assembly comprises a stem holder 234, a slider 236, and a retaining ring 238. The valve head 226 is configured between the piston 210 and the stem holder 234. The valve head or stem head 226 sits within the stem holder 234, which further reduces the overall shut-height of the system. The stem holder 234 sits on top of the slider 236 and is in sliding relationship with the slider 236 and the bottom portion of the piston 210. The retaining ring 238 secures the slider 236 and stem holder 234 within the underside of the piston 210. The sliding relationship between the stem holder 234, the slider 236, and bottom portion of the piston 210 permits the valve pin 230 to move laterally and independent of the lateral position of the piston 210 to accommodate relative changes in the positions of the manifold 202 and actuation assembly 200 caused by the thermal expansion and contraction. This particular configuration also limits the axial movement of the slider 236 and the valve head 226 relative to each other improving alignment and decreasing loads on the components. To accommodate lateral displacements in any direction, the clearances of the stem holder 234, the slider 236, and the piston 210 may be configured radially, that is 360° around the central or longitudinal axis of valve pin 230.

The nozzle locator 224, as shown in FIG. 2, differs from conventional systems due to its seating arrangement with respect to the manifold plate 204. As shown in FIG. 2, the nozzle assembly 211 extends through a recess in the manifold plate 204. The nozzle locater 224 is sandwiched between the outside surface of the nozzle assembly 211 and the manifold plate 204. The nozzle locater has an annular flange that contacts the outside surface of the nozzle assembly 211. The manifold plate 204 contains a first manifold plate shelf 228 and a second manifold plate shelf 226 adjacent the recess. The nozzle locator 224 has a first support arm. The first support arm is seated on the first manifold plate shelf 228. The nozzle locater 223 reduces shut-height and distributes the drop load over a larger area within the manifold plate 204 and may reduce the local deformation of the clamp side of the manifold plate (not shown) that is common to hot runners.

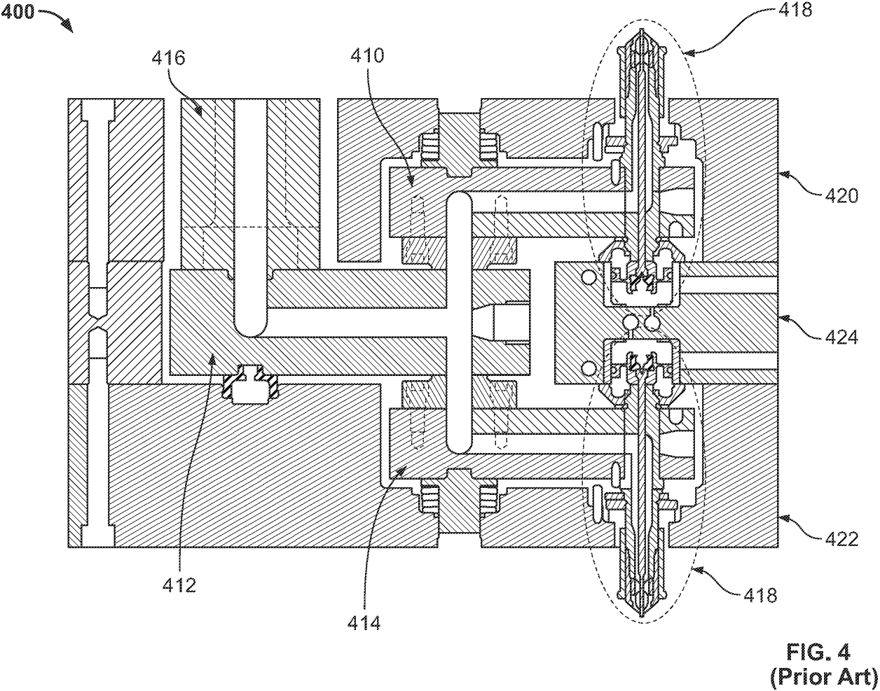

FIG. 4 illustrates the standard stack arrangement for a hot runner system 400. The melted resin distribution system is typically comprised of a sprue bar 416 that feeds a cross manifold 412. The cross manifold 412 feeds the main manifold(s) 414 on the clamp and injection sides of the system which then feed the nozzle stacks 418 on the clamp manifold plate 422 and the injection manifold plate 420. System 400 employs the same conventional nozzle design and actuation methods as the in the single face layout system 100 previously described. The plate arrangement, however, is slightly different, as an additional center plate 424 is required. The center plate 424 includes the air line/circuit routing and cylinder installations for the drops. Additionally, system 400 includes the two manifold plates 422 and 420, one each for the injection and clamp sides, and both manifold plates are secured to the center plate 424.

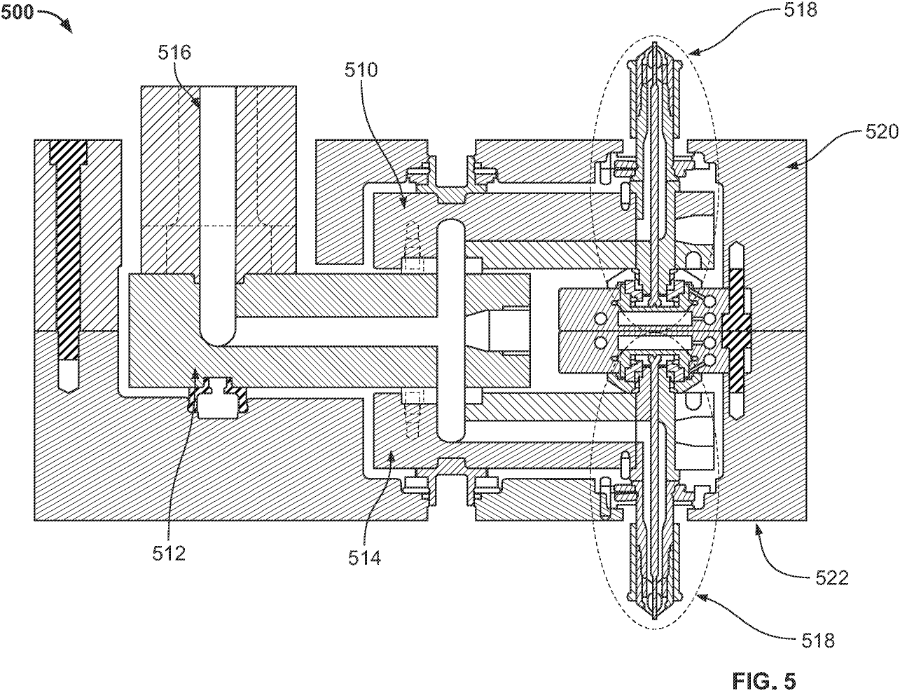

FIG. 5 illustrates the unique stack valve gate hot runner arrangement for a system with the compact stack valve gate disclosed herein. The actuation hardware of system 500 is identical to the configuration described in system 200 and shown in FIGS. 2 and 3. The insulator board 206, however, is no longer required as the configuration of system 500 includes an injection manifold plate 520 secured to a claim manifold plate 522 to contain the melted resin distribution system. System 500 does not require a conventional center plate, as shown in FIG. 4, as the actuation hardware is mounted in the drop plate and the air and cooling circuits are routed through the manifold plates. As a result, the system 500 has a reduced shut-height and overall weight.

FIG. 5 depicts the system 500 having a first drop plate fastened to an injection manifold plate 520 and a second drop plate fastened to clamp manifold plate 522. Each drop plate houses an actuating system described above and shown in FIGS. 2 and 3. While the embodiment shown FIG. 5 depicts separate drop plates in close proximity to other, an alternative embodiment may have the back-to-back drop plates formed from a unitary piece of material. The unitary drop plate may house both actuating systems, wherein a first actuating system is housed on one side of the unitary drop plate and a second actuating system is housed on the other side of the unitary drop plate. The unitary drop plate may be fastened to either the injection manifold plate 520 or the clamp manifold plate 522.

The present disclosure is disclosed above and in the accompanying drawings with reference to a variety of examples. The purpose served by the disclosure, however, is to provide examples of the various features and concepts related to the disclosure, not to limit the scope of the invention. One skilled in the relevant art will recognize that numerous variations and modifications may be made to the examples described above without departing from the scope of the present disclosure.

We claim:

1. A hot runner system comprising:
a plurality of nozzles;
a plurality of corresponding drop plates, wherein each drop plate is independent of the other drop plates and is dedicated to a single nozzle.

2. The hot runner system of claim 1 wherein each drop plate defines a cylinder wall that a piston rides within; and a valve pin associated with each drop plate and each nozzle, the valve pin configured to extend from the piston through at least a portion of a nozzle melt channel such that a forward end of the valve pin is seatable within the mold gate.

3. The hot runner of claim 2 wherein an upper chamber of the cylinder is sealed in essentially air-tight fashion by a sealing element arranged between the inner wall of the drop plate and the outer wall of the piston.

4. The hot runner system of claim 1, wherein the drop plates attached to separate manifold plates, and wherein each drop plate is associated with a separate manifold, and each drop plate is configured to seal melted resin within a manifold cavity in the manifold.

5. The hot runner system of claim 1, further comprising an insulator board configured to cover the plurality of drop plates and plurality of nozzles to reduce system contaminants.

6. The hot runner system of claim 1, wherein each drop plate further comprises a cooling circuit.

7. The hot runner system of claim 2, wherein each drop plate further comprises a plurality of pressurized circuits to drive the piston between an open position to a closed position.

8. The hot runner system of claim 1 wherein each drop plate is configured to generate a load providing a resin sealing function between a housing of the nozzle and a manifold bushing.

9. An injection molding system comprising:
a first manifold plate;
a second manifold plate;
a drop plate located between the first manifold plate and the second manifold plate and configured to be fastened to either the first manifold plate or the second manifold plate; wherein a first portion of the drop plate defines a first cylinder wall that a first piston rides within and second portion of the drop plate defines a second cylinder wall that a second piston rides withing;
a first valve pin configured to connect to the first piston and extend through at least a portion of a first nozzle melt channel such that a forward end of the first valve pin is seatable within a first mold gate;
a second valve pin configured to connect to the second piston and extend through at least a portion of a second nozzle melt channel such that a forward end of the second valve pin is seatable within a second mold gate;.

10. The hot runner system of claim 9, wherein the drop plate comprises at least one cooling circuit.

11. The hot runner system of claim 9, wherein the drop plate further comprises pressurized circuits to drive the first piston and the second piston between an open position to a closed position.

12. An injection molding system comprising:
a plurality of nozzles;
a plurality of corresponding drop plates, wherein each drop plate is independent of the other drop plates and is dedicated to a single nozzle, wherein each drop plate defines a cylinder wall that a piston rides within; and
a valve pin associated with each drop plate and configured to engage the piston;
a valve pin connection assembly configured to connect the valve pin to the piston, wherein the valve pin connection assembly is configured to permit axial movement of the valve pin relative to the piston.

13. The injection molding system of claim 12, wherein the valve pin connection assembly comprises a stem holder, slider, and a retaining ring, wherein a stem head of the valve pin is seated between the stem holder and a bottom portion of the piston, wherein the retaining ring retains the slider to the piston, and wherein the stem holder is configured to be in sliding engagement with the slider and the bottom portion of the piston to permit the valve pin to move in a lateral direction independent from a lateral position of the piston.

14. The injection molding system of claim 12, wherein the drop plate further comprises a cooling circuit and a plurality of air circuits to drive the piston between an open position to a closed position.

15. The injection molding system of claim 12, wherein each drop plate is configured to generate a load providing a resin sealing function between a housing of the nozzle and a manifold bushing.

16. An injection molding system comprising:
a melted resin distribution system comprising a first manifold and a second manifold;
a first drop plate configured to connect to a first manifold plate, the first drop plate defining a cylinder that a first piston rides within, and first drop plate dedicated to a first nozzle;
a second drop plate configured to abut the first drop plate and configured to connect to a second manifold plate, the second drop plate defining a first cylinder that a first piston rides within, and second drop plate dedicated to a second nozzle;
wherein the first drop plate and second drop plate are located between the first manifold plate and the second manifold plate.

17. The injection molding system of claim 16 wherein each drop plate contains a valve pin connection assembly configured to connect a valve pin to the piston, wherein the valve pin connection assembly is configured to permit axial movement of the valve pin relative to the piston.

18. The injection molding system of claim 17, wherein the valve pin connection assembly comprises a stem holder, slider, and a retaining ring, wherein a stem head of the valve pin is seated between the stem holder and a bottom portion of the piston, wherein the retaining ring retains the slider to the piston, and wherein the stem holder is configured to be in sliding engagement with the slider and the bottom portion of the piston to permit the valve pin to move in a lateral direction independent from a lateral position of the piston.

19. The injection molding system of claim 16, wherein each of the first and second drop plates further include a cooling circuit and a pressured circuit for driving each of the pistons between an open position and a closed position.

20. The injection molding system of claim 16 wherein each drop plate is configured to generate a load providing a resin sealing function between a housing of the nozzle and a manifold bushing.
